(19) United States
(12) Patent Application Publication
(10) Pub. No.: US 2009/0268109 A1
(43) Pub. Date: Oct. 29, 2009

(54) Digital Projection System

(76) Inventors: Clay Schluchter, Los Altos, CA (US); Ronald P. Bevis, Morgan Hill, CA (US); Robert Todd Belt, Sunnyvale, CA (US); Alan C. Graham, Cupertino, CA (US); Rainhold Garbe, San Jose, CA (US); Vince Barich, Palo Alto, CA (US); Mike Detro, Los Gatos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/111,944

(22) Filed: Apr. 29, 2008

(51) Int. Cl. G02F 1/1335

(52) U.S. Cl. 349/9

(57) ABSTRACT

A light modulation assembly and an image projector utilizing a plurality of such light modulation assemblies are disclosed. The light modulation assembly includes an optical element, a pre-polarization filter, an image modulator, and an analyzer polarization filter. The optical element has an input port for receiving a light beam. The optical element directs the light beam onto the pre-polarization filter that removes light having a linear polarization in a first direction. The light leaving the pre-polarization filter illuminates the image modulator. The light leaving the image modulator is filtered by the analyzer polarization filter to remove light having a linear polarization with a predetermined direction relative to the first direction. The light leaving the analyzer polarization filter exits the optical element through an output port. A plurality of such assemblies can be combined with a beam splitting assembly to provide an image projector.

### BACKGROUND OF THE INVENTION

Projectors for large screen displays to replace conventional film based projectors in motion picture viewing applications must provide high contrast ratios and high light intensities. One class of projector is based on image modulators such as liquid crystal displays (LCDs). When a polarized illumination source is projected on the LCD, the polarization of the light at each pixel is rotated depending on the signal applied to that pixel. A polarization filter processes the light leaving the LCD to block the light whose polarization has been altered.

Polarization filters based on polarization dependent beam splitters have problems in high illumination intensity applications such as projectors for large screen displays. Such beam splitters are based on a coating at a diagonal plane through a glass cube. The light must pass through the glass both before and after the separation of the light into the two linearly polarized components. Stress in the glass can be created by the machining and polishing operations used in the fabrication process and by non-uniform heating of the glass during the operation of the projector. Some of the light is absorbed in the glass and results in a heating of the glass structure. The heat from the absorbed light must be dissipated through the outer edges of the cube, and hence, a thermal gradient is present. The thermal gradient gives rise to stress birefringence that varies across the polarization filter. The stress birefringence converts the linearly polarized light to elliptically polarized light. As a result, some of the light is passed by the LCD pixels when the pixels are set to block light, and some of the light is blocked when the pixels are set to transmit light. This leads to a decrease in the contrast ratio of the LCD. In addition, the contrast ratio varies over the surface of the LCD panel.

To provide high contrast ratio LCD panels, the material from which the beam splitting prism is constructed must exhibit low stress birefringence and/or reduced light absorption. Glass that provides these properties is expensive. In addition, some of these glass compositions include large amounts of lead, and hence, are subject to environmental restrictions.

The problems of stress birefringence can be reduced by utilizing polarization filters that do not require the glass structures discussed above. One such polarization filter is known as a wire grid polarizer. Wire grid polarizers are known to the art, and hence, will not be discussed in detail here. An example of such a polarizer is taught in U.S. Pat. No. 5,986,730, which is hereby incorporated by reference. For the purposes of the present discussion, it is sufficient to note that a wire grid polarizer can be configured to transmit light of a first linear polarization and reflect light of the orthogonal polarization. The polarizer does not require the glass components discussed above, and hence, avoids the stress birefringence problems discussed above.

In an LCD projector system, three LCD panels are required to provide a color projector. The light from an incandescent or other white light source is split into three component bands that are processed by the LCD panels. The modulated light from the LCD panels must then be recombined to produce a color image that is projected onto the screen. The path lengths traversed by each color of light from the light source to the projection screen is preferably the same. If the path lengths are not the same, additional optical components such as lenses are required to compensate for the path differences. The lenses preferably are surrounded by air to provide the optical imaging function without requiring high index of refraction glass. Hence, a number of components with air interfaces are needed, which complicates the construction of the projector and increases the cost.

### SUMMARY OF THE INVENTION

The present invention includes a light modulation assembly and an image projector utilizing a plurality of such light modulation assemblies. The light modulation assembly includes an optical element, a pre-polarization filter, an image modulator, and an analyzer polarization filter. The optical element has an input port for receiving a light beam. The optical element directs the light beam onto the pre-polarization filter that removes light having a linear polarization in a first direction. The light leaving the pre-polarization filter illuminates the image modulator. The light leaving the image modulator is filtered by the analyzer polarization filter to remove light having a linear polarization with a predetermined direction relative to the first direction. The light leaving the analyzer polarization filter exits the optical element through an output port. In one embodiment, the light beam traverses an input optical path from the input port to the image modulator and an output optical path from the image modulator to the output port, the input optical path being substantially equal to the output optical path in length. The space between the pre-polarization filter and the light modulator and the space between the light modulator and the analyzer polarization filter are devoid of any material that substantially rotates the polarization of light.

A plurality of light modulation assemblies can be combined to provide a projector. A projector according to the present invention includes first and second light modulation assemblies and a beam splitting assembly. Each of the light modulation assemblies includes an optical element, a pre-polarization filter, an image modulator, and an analyzer polarization filter. The optical element has an input port for receiving a light beam. The optical element directs the light beam onto the pre-polarization filter that removes light having a linear polarization in a first direction. The light leaving the pre-polarization filter illuminates the image modulator. The light leaving the image modulator is filtered by the analyzer polarization filter to remove light having a linear polarization with a predetermined direction relative to the first direction. The light leaving the analyzer polarization filter exits the optical element through an output port.

The beam splitting assembly includes an optical element having an input port for receiving an input light beam and an output port for transmitting a spatially modulated output light beam. The beam splitting assembly generates a first light beam having light in a first optical band and a second light beam having light in a second optical band from the input light beam and directs the first light beam into the input port of the first light modulation assembly and the second light beam into the input port of the second light modulation assembly. The first light beam follows a path having a first optical path length from the input port of the beam splitting assembly to the first image modulator, and the second light beam follows a path having a second optical path length from the input port of the beam splitting assembly to the second image modulator. The first optical path length is substantially equal to the second optical path length.

In one embodiment, the beam splitting assembly also combines light leaving the output ports of the first and second light modulation assemblies to form the spatially modulated output light beam. The first light beam follows a path having a third optical path length from the output port of the first modulation assembly to the output port of the beam splitting assembly, and the second light beam follows a path having a fourth optical path length from the output port of the second modulation assembly to the output port of the beam splitting assembly. The third optical path length is substantially equal to the fourth optical path length.

### BRIEF DESCRIPTION OF THE DRAWINGS

FIG. 1 is a perspective view of a light modulation assembly according to one embodiment of the present invention.

FIGS. 2A-2E illustrate a three color projector assembly according to one embodiment of the present invention.

FIG. 3 illustrates another embodiment of a light modulation assembly according to the present invention.

FIG. 4 illustrates another embodiment of a projector assembly according to the present invention.

FIG. 5 illustrates yet another embodiment of a projector assembly according to the present invention.

### DETAILED DESCRIPTION OF THE PREFERRED EMBODIMENTS OF THE INVENTION

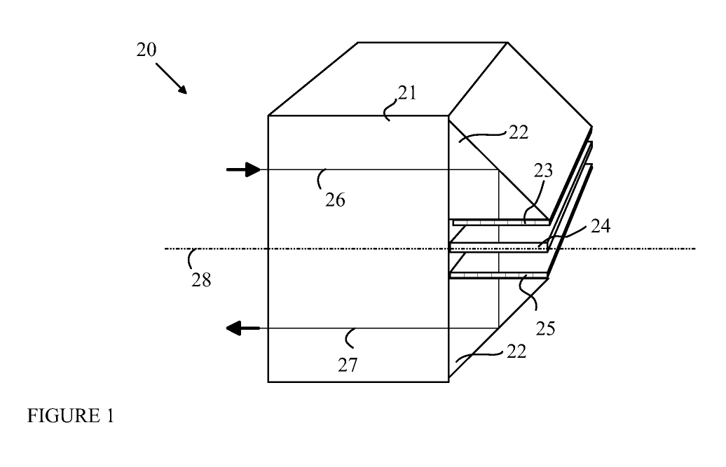

The manner in which the present invention provides its advantages can be more easily understood with reference to FIG. 1, which is a perspective view of a light modulation assembly according to one embodiment of the present invention. Light modulation assembly 20 includes an optical element and an imaging assembly. Light modulation assembly 20 modulates a light beam on path 26 in the optical element according to a spatial pattern provided on LCD panel 24 in the imaging assembly. The modulated light beam exits on path 27. Paths 26 and 27 are symmetrically located with respect to the plane 28 of the LCD panel.

The LCD panel can be viewed as a two-dimensional array of small pixels that operate on the light passing through each pixel. The panel is illuminated with linearly polarized light. In one state, each pixel merely passes the light without altering the direction of polarization of the light. In the other state, each pixel rotates the polarization of the light to the orthogonal direction. The incident light is typically linearly polarized in the desired direction by a polarization filter. The light that leaves the LCD panel with its polarization rotated is processed by a second polarization filter that is oriented to pass only light of the desired polarization, thereby eliminating light that was processed by pixels in one of the two states. As noted above, any material between the polarization filters and LCD panel that alters the polarization of the light results in a reduced contrast ratio for the imaging system.

The imaging assembly includes wire grid polarizer filter 23, LCD panel 24, and wire grid polarizer filter 25. Wire grid polarization filter 23 acts as a pre-light modulation polarization filter that removes light having one linear polarization to provide an illumination source that consists of light of a predetermined linear polarization. The light leaving LCD panel 24 has been spatially modulated by changing the polarization of the light at each of the pixels. The light leaving the LCD panel is processed by a second wire grid polarization filter 25 with its axis set to eliminate light of the unwanted polarization.

The light leaving polarization filter 25 is reflected back along path 27. The optical element is a monolithic glass part that is constructed from a rectangular body 21 and a pair of angular members 22 having reflective surfaces that direct the light through the modulating assembly. However other arrangements could be utilized. It should be noted that stress birefringence in the optical element does not significantly alter the polarization of the light passing through LCD panel 24, and hence, the problems associated with stress birefringence discussed above are alleviated.

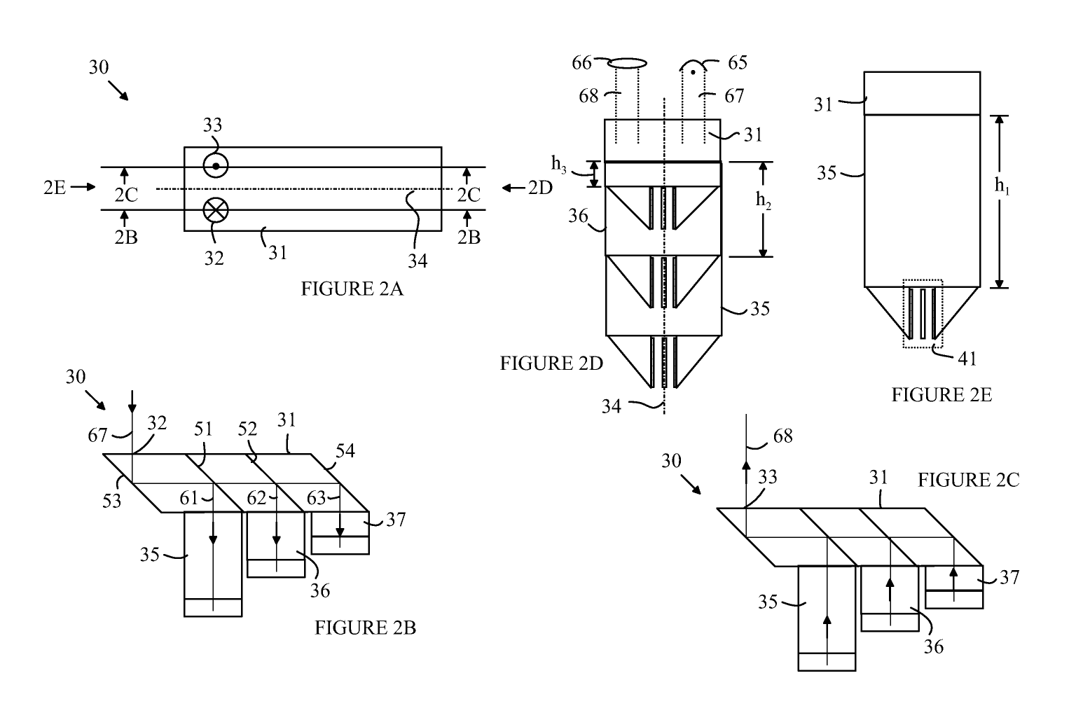

Refer now to FIGS. 2A-2E, which illustrate a three-color projector assembly according to one embodiment of the present invention. FIG. 2A is a top view of projector assembly 30. FIGS. 2B and 2C are cross-sectional views of projector assembly 30 through lines 2B-2B and 2C-2C, respectively. FIG. 2D is an end view of projector assembly 30 as seen from arrow 2D in FIG. 2A, and FIG. 2E is an end view of projector assembly 2A as seen from arrow 2E shown in FIG. 2A. Projector assembly 30 operates on an input light beam 67 from a multicolor light source 65 to spatially modulate light beam 67 such that an image is generated on a screen by projection lens 66.

Projector assembly 30 can be viewed as having 4 components, a light separation and combining assembly 31 and 3 light modulating assemblies 35-37 that operate in a manner analogous to light modulation assembly 20 discussed above. Beam splitting and combining assembly 31 is a 3 axis rhomb beam splitter that includes two chromatic beam splitters 51 and 52 and two reflectors 53 and 54. A multicolor light beam entering beam splitting and combining assembly 31 in region 32, which acts as an input port, is split into three beams having different colors as shown at 61-63, respectively. Chromatic beam splitter 51 reflects light in a first band of wavelengths while transmitting light in the other bands to generate beam 61. For example, chromatic beam splitter 51 could reflect light in a band of wavelengths around a wavelength in the red region. The blue and green components of the input light beam would then strike chromatic beam splitter 52, which reflects light in a second band of wavelengths, e.g., a band around a wavelength in the green region of the optical spectrum, to create beam 62. The light transmitted by chromatic beam splitter 52 is then reflected by reflector 54 to form beam 63, which includes light in a third band of wavelengths, e.g., a band around a wavelength in the blue region of the optical spectrum. Reflector 54 can be either a chromatic beam splitting surface or a non-wavelength specific reflector.

The light in each of the beams is processed by a corresponding light modulation assembly. The light modulating assemblies corresponding to beams 61-63 are shown at 35-37, respectively. Each light modulation assembly includes a light pipe and an imaging assembly. The imaging assembly for light modulation assembly 35 is labeled in FIG. 2E at 41. The light pipes for the various light modulation assemblies differ in length as shown at h₁-h₃. The lengths of the light pipes are chosen such that the optical path for light entering port 32 and arriving at an LCD in one of the light modulation assemblies is the same regardless of the light modulation assembly that processed that light. This assures that each LCD subtends the same solid angle with respect to input port 32. In the absence of this arrangement, a lens must be incorporated in one or more of the light modulation assemblies to correct for the differences in solid angle, as input light source 65 typically generates a beam that has some degree of divergence.

In addition, the light pipes are also preferably chosen such that the optical path length from the LCD panel in each of the light modulation assemblies to output port 33 is the same for all of the light modulation assemblies. If this condition is not met, projection lens 66 operating on the output light beam 68 will generate an image in which one or more of the component color images is out of focus with respect to another of the component color images. In the arrangement shown in FIGS. 2A-2E, the optical path length from input port 32 to each LCD panel is arranged to be the same as the optical distance from each LCD panel to output port 33 by placing the LCD panels on the center plane shown at 34.

The embodiments illustrated in FIGS. 2A-2E utilize an arrangement in which each of the light modulation assemblies has an optical element with a height h greater than 0. However, embodiments in which h₃ is zero could also be utilized. In such an embodiment, the reflective section of the light pipe would be mounted directly to beam splitting and combining assembly 31.

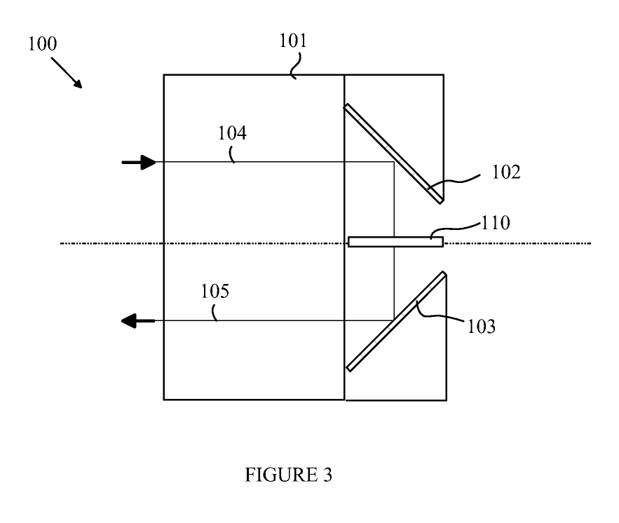

The above-described embodiments utilize a light modulation assembly in which the polarization filters are wire grid polarizers operating in a transmissive mode. That is, the light that is modulated by the LCD panel is the light that passes through the wire grid polarizer. However, embodiments in which the wire grid polarizers operate in a reflective mode can also be constructed. Refer now to FIG. 3, which illustrates another embodiment of a light modulation assembly according to the present invention. Light modulation assembly 100 includes an optical element 101 that directs an input light beam toward a wire grid polarizer 102 that is positioned such that the light reflected from the wire grid polarizer is polarized in the desired direction. The polarized light then passes through LCD panel 110, which spatially modulates the polarization of the polarized light. Light of the desired polarization is then reflected back into optical element 101 along path 105 by analyzer polarization filter 103. Path 105 is symmetrically placed with respect to path 104 and LCD panel 110.

The advantages provided by the wire grid polarizers are the result of two properties of this type of polarization filter. First, the effective thickness of the light modulation assembly in the case of the transmissive polarization filters shown in FIG. 1 is reduced because only the filter thickness affects the total thickness. In arrangements in which the polarization filter is tilted at an angle with respect to the LCD panel, the thickness of the light modulation assembly is increased by an amount that depends on the length or width of the filter and the angle of inclination of the filter relative to the LCD panel.

Second, the wire grid polarizers make possible designs in which there is no glass between the polarization filters and the LCD panel. Hence, the polarization state of the light leaving the pre-modulation polarization filter is not altered by stress birefringence in the medium between the filter and the LCD panel. Similarly, the polarization of the light leaving the LCD panel is not altered by stress birefringence in the medium between the LCD panel and the analyzing filter.

The above-described embodiments utilize wire grid polarizers as the pre-polarizing filter and the analyzer polarization filter after the LCD panel. However, other forms of polarizers could be utilized for these functions. For example, a reflective surface in which the light is reflected at the Brewster angle generates a linearly polarized reflected light beam. Hence, one or both of the wire grid polarizers shown in FIG. 3 could be replaced with a reflective surface oriented at the Brewster angle. Since a Brewster angle polarizer produces the polarized light beam utilizing the reflected light from a transparent surface, stress birefringence problems in the medium having the transparent surface in question do not interfere with operation of the imaging assembly. The need to provide the angled surface, however, does increase the size of the resulting projector.

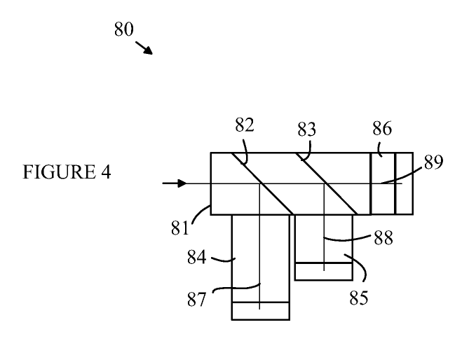

The embodiments of the projector assembly discussed above with reference to FIGS. 2A-2E utilized a particular rhomb beam splitter-combiner configuration. However, other configurations of a beam splitter-combiner element could be utilized as long as the optical paths for each of the light modulation assemblies satisfy the conditions discussed above. Refer now to FIG. 4, which illustrates another embodiment of a projector assembly according to the present invention. FIG. 4 is a cross-sectional view of projector assembly 80 through the input plane of the beam splitter-combining element 81. Beam splitter-combiner 81 includes two dichroic beam splitters 82 and 83 that form the two color component beams 87 and 88, respectively. The remainder of the light from the input beam exits the end of beam splitter-combiner 81 to form the third color component beam 89. The component color beams are processed by light modulation assemblies 84-86 in a manner analogous to that discussed above with respect to the embodiments shown in FIGS. 2A-2E.

The above-described embodiments of a projector assembly utilize an input light source having three color components that are divided out into three color beams that are each processed by a light modulation assembly. However, projector assemblies having different numbers of component light beams and light modulation assemblies can also be constructed using the present invention.

In the above-described embodiments of the present invention, various optical paths are referred to as being equal in optical path length. It will be appreciated that these optical paths need only be substantially equal in length for the present invention to provide its advantages. For the purposes of this discussion, two output optical paths will be defined as being substantially equal if the images of the LCD panel in each of the light modulating assemblies are both in focus on a projector screen when viewed by human observer. Similarly, two input optical paths will be defined to have substantially the same optical path length if the differences in the solid angle subtended by the two corresponding LCD panels cause intensity differences in the images generated by the two LCD panels that are less than an intensity difference that a human observer can observe.

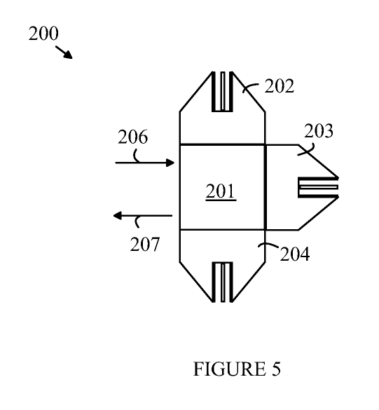

The above described embodiments of projectors according to the present invention utilize rhomb beam splitters to split the input light beam into the component color light beams and recombine the spatially modulated light beams. However, embodiments that utilize other forms of beam splitter for these functions can also be constructed. Refer now to FIG. 5, which illustrates another embodiment of a projector optical assembly according to the present invention. Assembly 200 utilizes an X-cube beam splitter 201 to split the input light beam 206 into 3 light beams having different colors. The first beam is reflected into light modulation assembly 202, the second beam is reflected into light modulation assembly 204 and the remaining beam passes through beam splitter 202 and enters light modulation assembly 203. The spatially modulated light beams leaving the various light modulation assemblies are then recombined into an output beam 207 by beam splitter 201.

The above-described embodiments of the present invention utilize LCD panels as the image modulator. However, embodiments of the present invention that utilize other forms of image modulator that modulate the polarization of the light could be utilized. For example, light modulators based on ferro-electrics are known to the art.

It should be noted that the polarization filters and the above-described filters could be multi-layer filters in which each layer reflects light of a particular polarization and wavelength.

Various modifications to the present invention will become apparent to those skilled in the art from the foregoing description and accompanying drawings. Accordingly, the present invention is to be limited solely by the scope of the following claims.

What is claimed is:

1. An apparatus comprising:
a light modulation assembly comprising:
an optical element, a pre-polarization filter, an image modulator, and an analyzer polarization filter,
said optical element having an input port for receiving a light beam, said optical element directing said light beam onto said pre-polarization filter that removes light having a linear polarization in a first direction, said light leaving said pre-polarization filter illuminating said image modulator, said light leaving said image modulator being filtered by said analyzer polarization filter to remove light having a linear polarization with a predetermined direction relative to said first direction, said light leaving said analyzer polarization filter exiting said optical element through an output port, wherein said light beam traverses an input optical path from said input port to said image modulator and an output optical path from said image modulator to said output port, said input optical path being substantially equal to said output optical path in length.

2. The apparatus of claim 1 wherein said image modulator comprises an LCD panel.

3. The apparatus of claim 1 wherein said pre-polarization filter is separated from said image modulator by a space and that space is devoid of any material that substantially rotates the polarization of light leaving said pre-polarizing filter.

4. The apparatus of claim 1 wherein said analyzer polarization filter is separated from said image modulator by a space and that space is devoid of any material that substantially rotates the polarization of light leaving said image modulator.

5. The apparatus of claim 1 wherein said image modulator is located in a plane and said input optical path and said output optical path are symmetrically located about said plane.

6. The apparatus of claim 1 wherein said pre-polarization filter comprises a wire grid polarizer.

7. The apparatus of claim 1 wherein said pre-polarization filter comprises a Brewster angle polarizer.

8. An apparatus comprising:
first and second light modulation assemblies and a beam splitting assembly,
said first and second light modulation assemblies each comprising:
an optical element, a pre-polarization filter, an image modulator, and an analyzer polarization filter,
said optical element having an input port for receiving a light beam, said optical element directing said light beam onto said pre-polarization filter that removes light having a linear polarization in a first direction, said light leaving said pre-polarization filter illuminating said image modulator, said light leaving said image modulator being filtered by said analyzer polarization filter to remove light having a linear polarization with a predetermined direction relative to said first direction, said light leaving said analyzer polarization filter exiting said optical element through an output port; and
said beam splitting assembly comprising an optical element having an input port for receiving an input light beam and an output port for transmitting a spatially modulated output light beam, said beam splitting assembly generating a first light beam having light in a first optical band and a second light beam having light in a second optical band from said input light beam and directing said first light beam into said input port of said first light modulation assembly and said second light beam into said input port of said second light modulation assembly,
wherein said first light beam follows a path having a first optical path length from said input port of said beam splitting assembly to said first image modulator and said second light beam follows a path having a second optical path length from said input port of said beam splitting assembly to said second image modulator, said first optical path length being substantially equal to said second optical path length.

9. The apparatus of claim 8 wherein said beam splitting assembly further combines light leaving said output ports of said first and second light modulation assemblies to form said spatially modulated output light beam,
wherein said first light beam follows a path having a third optical path length from said output port of said first modulation assembly to said output port of said beam splitting assembly and said second light beam follows a path having a fourth optical path length from said output port of said second modulation assembly to said output port of said beam splitting assembly, said third optical path length being substantially equal to said fourth optical path length.

10. The apparatus of claim 9 wherein said image modulators in said first and second light modulation assemblies comprise LCD panels.

11. The apparatus of claim 9 wherein said beam splitting assembly comprises a beam splitting optical element having a dichroic beam splitter internal to said beam splitting optical element.

12. The apparatus of claim 11 wherein said first and second light modulation assemblies are bonded to said beam splitting optical element to provide a monolithic optical assembly.

13. The apparatus of claim 8 wherein said beam splitting assembly comprises a rhomb beam splitter.

14. The apparatus of claim 8 further comprising a light source for generating said input light beam, said input light beam having light in said first and second optical bands.

15. The apparatus of claim 8 wherein light entering said optical element of said first light modulation assembly traverses an optical path through said first light modulation assembly from said input port of said first light modulation assembly to said output port of that light modulation assembly characterized by a first light modulation assembly optical path length and light entering said optical element of said second light modulation assembly traverses an optical path through said second light modulation assembly from said input port of that light modulation assembly to said output port of that light modulation assembly characterized by a second light modulation assembly optical path length, said second light modulation assembly optical path length being different from said first light modulation assembly optical path length, said difference in optical path length compensating for differences in optical path lengths through said beam splitting assembly for said first and second light beams.

16. A method for spatially modulating an input light beam at an apparatus input port to form an output light beam at an apparatus output port, said method comprising:
splitting said input light beam into a first component light beam having light in a first band of the optical spectrum and a second component light beam having light in a second band of the optical spectrum;
directing said first component light beam to a first light modulation assembly and said second light beam to a second light modulation assembly, said first and second light modulation assembly spatially modulating said first and second component light beams to provide first and second spatially modulated output light beams;
combining said first and second spatially modulated output light beams to form said output light beam,
wherein said first and second light modulation assemblies each comprise:
an optical element, a pre-polarization filter, an image modulator, and an analyzer polarization filter,
wherein light entering said apparatus input port that is directed to said image modulator in said first light modulation assembly traverses an optical path having substantially the same optical path length as light entering said apparatus input that is directed to said image modulator in said second light modulation assembly.

17. The method of claim 16 wherein light leaving said image modulators of said first light modulation assembly and said second light modulation traverses first and second optical paths, respectively, in reaching said apparatus output port, said first optical path having substantially the same optical path length as said second optical path.

18. The method of claim 16 wherein:
said optical element in each of said light modulation assemblies has an input port for receiving a light beam, said optical element directing said light beam onto said pre-polarization filter that removes light having a linear polarization in a predetermined direction, said light leaving said pre-polarization filter illuminating said image modulator, said light leaving said image modulator being filtered by said analyzer polarization filter to remove light having a linear polarization with a direction different from said predetermined direction, said light leaving said analyzer polarization filter exiting said optical element through an output port, wherein said light beam traverses a input optical path from said input port to said image modulator and a output optical path from said image modulator to said output port, said first input optical path being substantially equal to said second optical path in length.

19. The method of claim 16 wherein said pre-polarization filter in each of said light modulation assemblies is separated from said image modulator in that light modulation assembly by a space and that space is devoid of any material that substantially rotates the polarization of light leaving said pre-polarizing filter.

20. The method of claim 19 wherein said analyzer polarization filter in each of said light modulation assemblies is separated from said image modulator in that light modulation assembly by a space and that space is devoid of any material that substantially rotates the polarization of light leaving said image modulator.
